(19) United States
(12) Patent Application Publication
(10) Pub. No.: US 2013/0133471 A1
(43) Pub. Date: May 30, 2013

(54) ADJUSTABLE PEDAL ASSEMBLY WITH SWING ARM

(71) Applicant: Magna Closures Inc., Newmarket (CA)

(72) Inventors: Andrei Tchernyi, Bolton (CA); William Winnitoy, Sandford (CA)

(73) Assignee: Magna Closures Inc., Newmarket (CA)

(21) Appl. No.: 13/656,405

(22) Filed: Oct. 19, 2012

Related U.S. Application Data
(60) Provisional application No. 61/565,208, filed on Nov. 30, 2011.

(51) Int. Cl. G05G 1/40

(52) U.S. Cl. CPC G05G 1/40
USPC 74/560

(57) ABSTRACT

In one aspect, an adjustable pedal assembly for a vehicle is provided, comprising a base, a swing arm, a pedal lever, a first link, and a second link. The base is mountable to a vehicular base support structure. The swing arm is pivotally mounted to the base about a first axis and has an end that defines a second axis that is substantially parallel to the first axis. The pedal lever is connected to the swing arm for pivotal movement about the second axis. The pedal lever has an input member that is used by a vehicle driver to depress the pedal lever, and an output member. The first link is pivotable about the first axis and has an output member connectable to an actuator, and an input member. The second link is pivotally connected to the first link input member and to the pedal lever output member.

### CROSS-REFERENCE TO RELATED APPLICATIONS

This application claims priority from U.S. Provisional Patent Application No. 61/565,208 filed Nov. 30, 2011, the contents of which are incorporated herein in their entirety.

### FIELD

This disclosure generally relates to the art of adjustable pedals, particularly vehicular brake and accelerator pedal assemblies whose position can be moved on demand.

### BACKGROUND

Adjustable pedal assemblies are a useful upgrade in a vehicle and commercially available. Commercial adjustable pedal assemblies are typically powered by an electric motor.

An example of a prior art adjustable pedal system is described in US Publication No. 2004/0250646. This design is a relatively complicated structure having a number of control links, pins and arcuate slot for controlling the motion of the accelerator pedal in conjunction with the brake pedal. A less complicated structure is desired.

### SUMMARY

According to one aspect, an adjustable pedal assembly for a vehicle is provided, comprising a base, a swing arm, a pedal lever, a first link, and a second link. The base is mountable to a base support structure in a vehicle. The swing arm is pivotally mounted to the base about a first axis and has a free end that defines a second axis that is substantially parallel to the first axis. The pedal lever has a pedal thereon and is connected to the swing arm for pivotal movement about the second axis. The pedal lever has an input member that is used by a vehicle driver to depress the pedal. The pedal lever has an output member. The first link is pivotable about the first axis and has an output member that is connectable to an actuator. The first link also has an input member. The second link is pivotally connected at a first end to the input member of the first link and at a second end to the output member of the pedal lever. As a result of the above-noted assembly, adjustment may be carried out on the angular position of the swing arm about the first axis thereby adjusting the position of the pedal, but without changing the amount of effort that is required to depress the pedal to actuate the actuator.

### BRIEF DESCRIPTION OF DRAWINGS

The foregoing and other aspects will be better appreciated with reference to the accompanying drawings, wherein:

FIG. 1 is a front perspective view of an embodiment of an adjustable pedal assembly;

FIG. 2 is an exploded elevation view of the adjustable pedal assembly;

FIG. 3 is a rear elevation view of the adjustable pedal assembly, with a cross-sectioned view at planes corresponding to axes A and B in FIG. 2;

FIG. 4 is a perspective view of part of the adjustable pedal assembly shown in FIG. 1 in a stage of assembly;

FIG. 5 is a perspective view of part of the adjustable pedal assembly shown in FIG. 1 in a more advanced stage of assembly relative to FIG. 4;

FIG. 6 is a perspective view of part of the adjustable pedal assembly shown in FIG. 1 in a more advanced stage of assembly relative to FIG. 5;

FIGS. 7A and 7B are perspective views, taken from different angles, of the adjustable pedal assembly shown in FIG. 1 in a more advanced stage of assembly relative to FIG. 6;

FIG. 8 is fragmentary perspective view of the adjustable pedal assembly shown in FIG. 1 in a more advanced stage of assembly relative to FIGS. 7A and 7B;

FIG. 9 is an isolated perspective view of an accelerator pedal assembly support structure employed in the adjustable pedal assembly shown in FIG. 1;

FIG. 10 is an isolated perspective view of a swing arm employed in the adjustable pedal assembly shown in FIG. 1;

FIG. 11 is a perspective view of a linkage employed in the adjustable pedal assembly shown in FIG. 1; and

FIG. 12 is a perspective view of a pedal lever assembly employed in the adjustable pedal assembly shown in FIG. 1.

### DETAILED DESCRIPTION OF EXAMPLE EMBODIMENTS

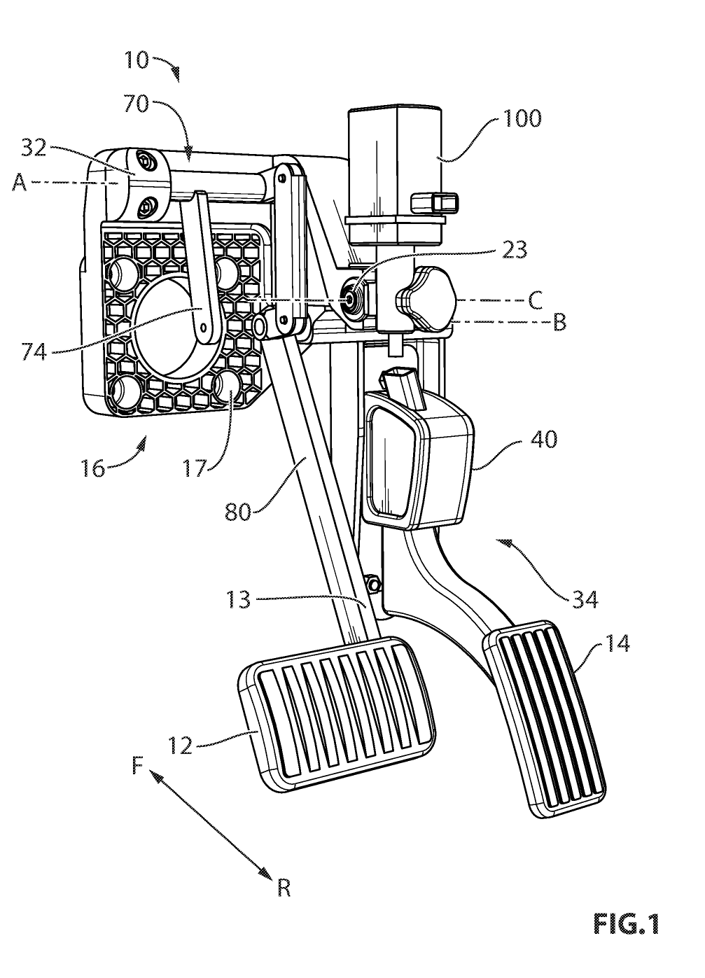

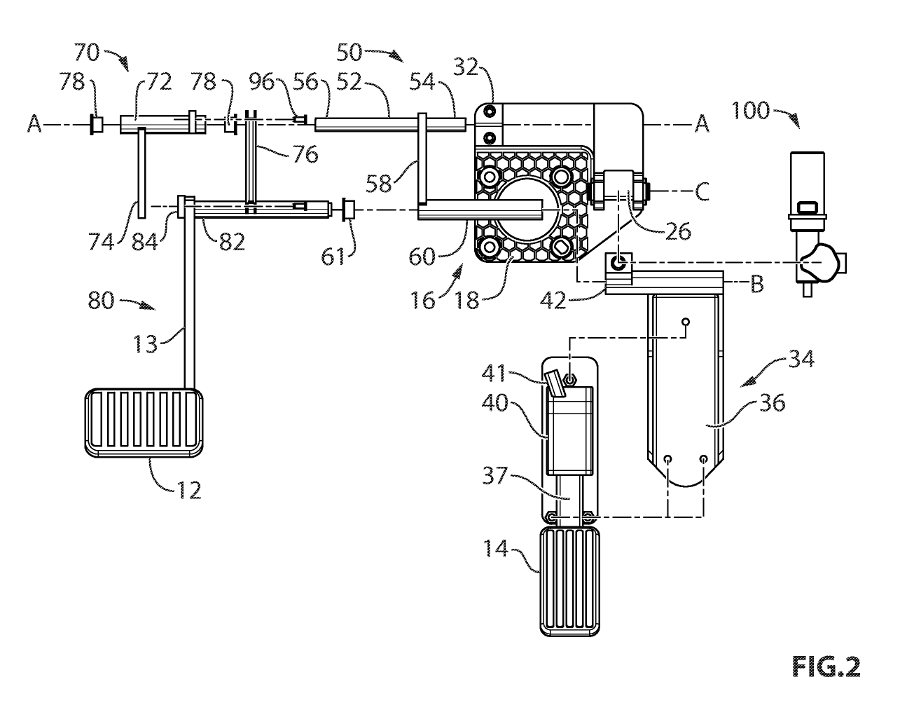

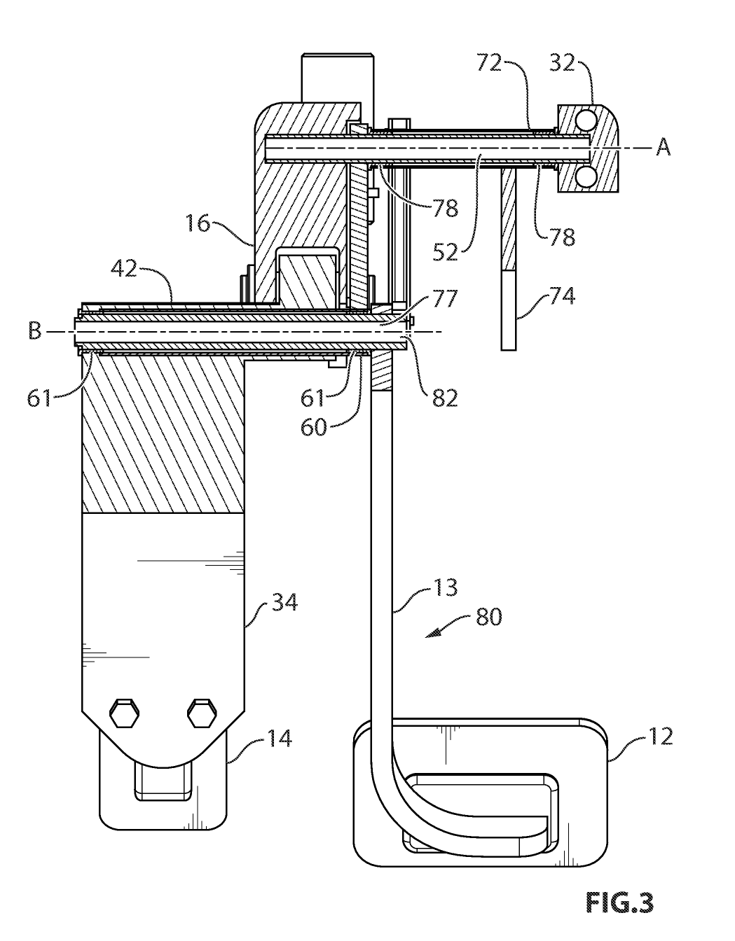

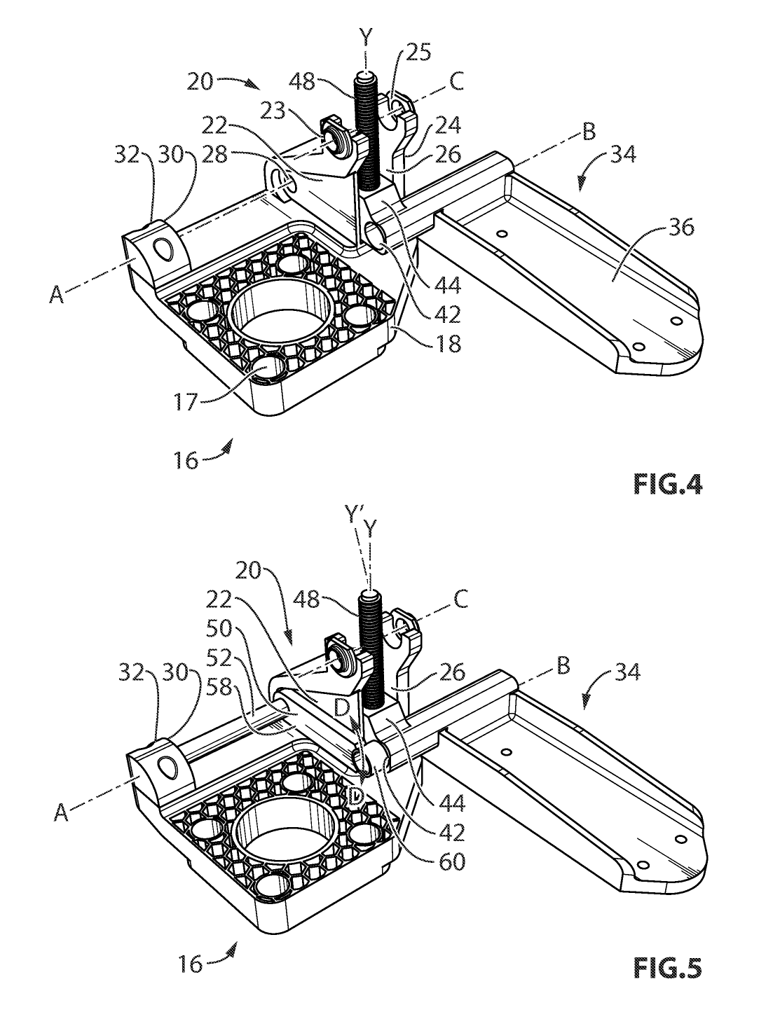

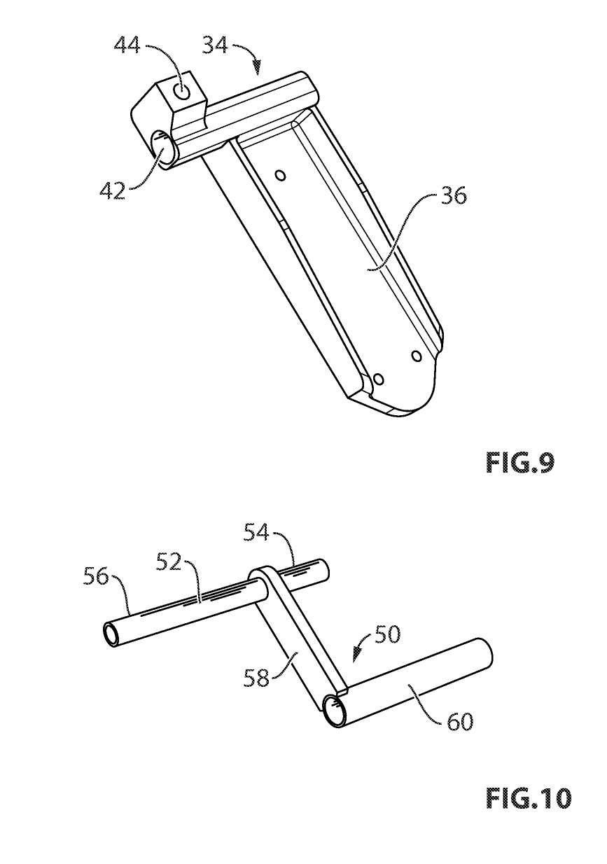

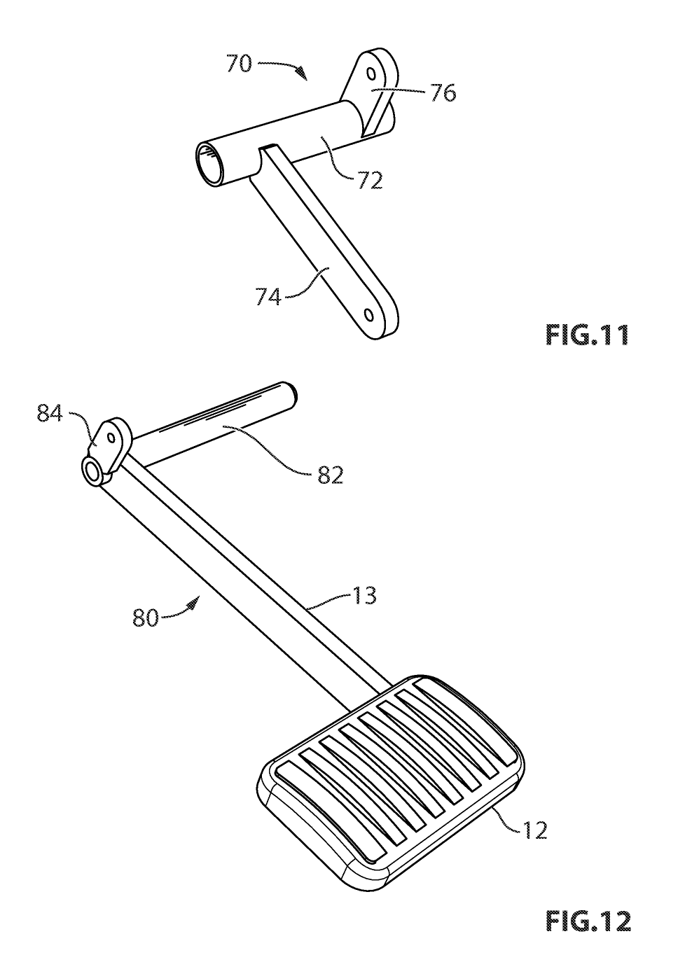

FIG. 1 shows an adjustable pedal assembly 10 including a brake pedal 12 and an accelerator pedal 14. FIG. 2 shows an exploded elevation view of the pedal assembly 10. FIG. 3 shows a rear elevation, partially cross-sectional, view of the pedal assembly 10. FIGS. 4-8 show fragmentary perspective views of the pedal assembly 10 in various stages of assembly, with each subsequent drawing successively building upon the partial assembly shown in the previous drawing. FIGS. 9-12 are perspective views of various components of the pedal assembly shown in isolation.

The adjustable pedal assembly 10 has a base 16 that is mountable to a support structure in a vehicle. For example, the base 16 may be secured to the firewall of the vehicle (not shown) via four mounting holes 17. The base 16 may be formed from a plastic composite material.

Referring to FIG. 4, the base 16 has a foot 18. A stand 20 is located at a corner of the foot 18 and extends transversely thereto. The stand 20 has two opposing walls 22 and 24 which define a channel 26 that is generally U-shaped in cross-section and that extends transversely to the foot 18.

One of the walls 22 has an aperture 28 that is aligned with another aperture 30 that is formed in a shaft mount 32. The shaft mount 32 may be a separable component that is secured to the foot 18 with one or more bolts or screws. Together, the shaft mounting holes 28 and 30 define a first axis A.

Referring to FIGS. 2 and 5, the assembly 10 includes a swing arm 50 that includes a swing arm pivot shaft 52 which has journals 54 and 56 that are mounted in the shaft mounting holes 28 and 30, respectively, so that the radial arm 58 lies adjacent to (and substantially parallel to) wall 22 of the stand 20. The swing arm pivot shaft 52 is thus pivotable about the first axis A.

The swing arm 50 further includes a radial arm 58 that extends radially outwardly from the pivot shaft 52, and a swing arm free end shaft 60 that is fixedly connected to the free end (i.e. the radially outer end) of the radial arm 58. The shaft 60 defines a second pivot axis B that is substantially parallel to the first pivot axis A.

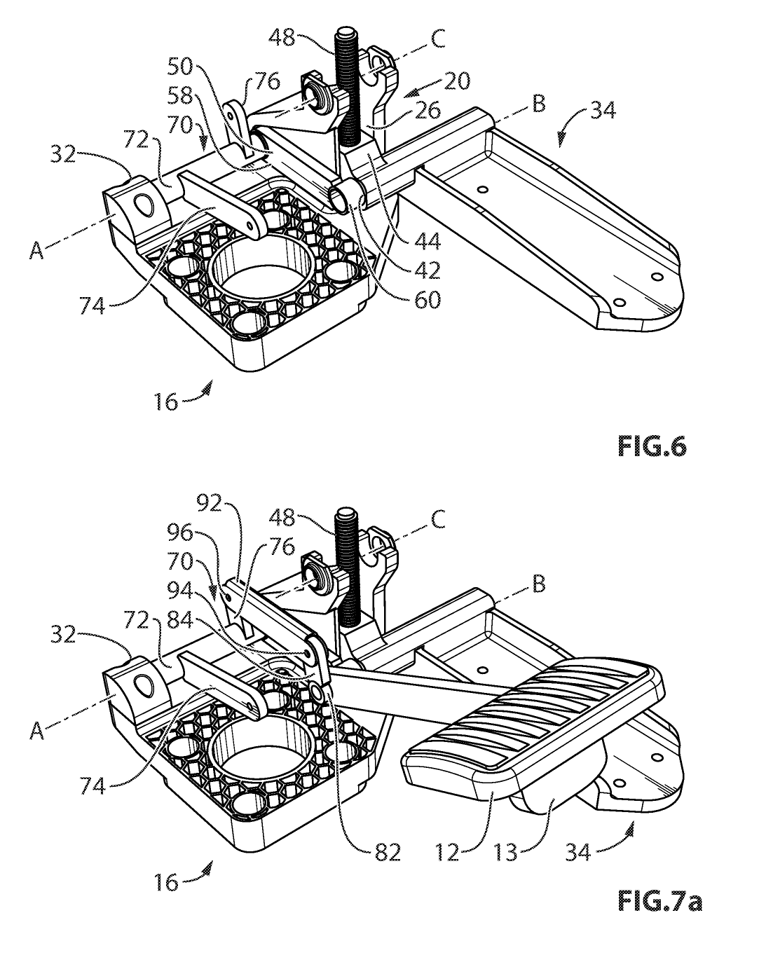

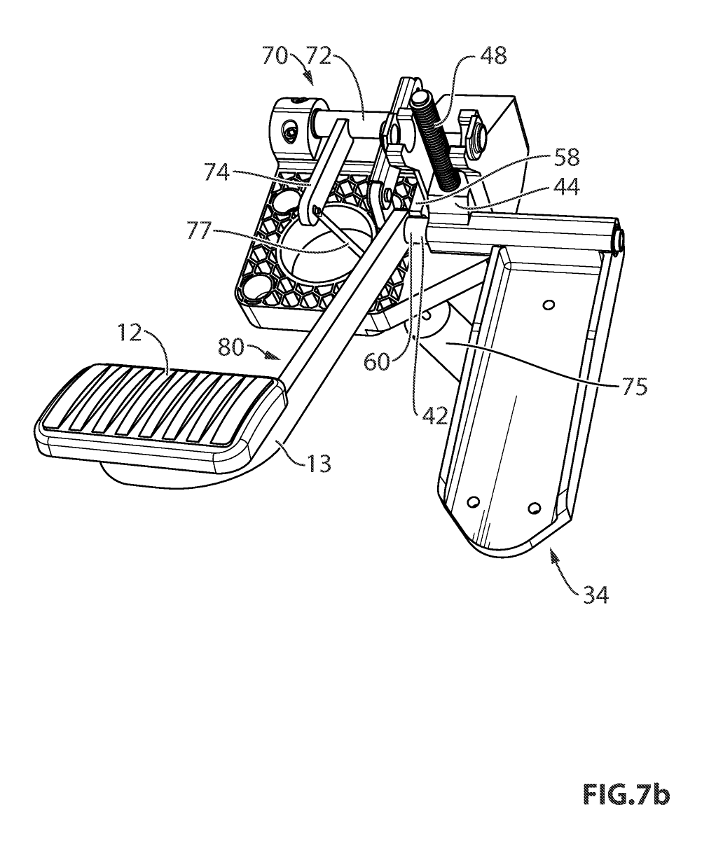

On the swing arm pivot shaft 52 is a pair of bushings 78. Referring to FIGS. 2 and 6, a linkage includes a first link 70 which is a rotary link that includes a sleeve 72 that is supported on exterior surfaces of the bushings 78 and is thus concentrically mounted over the swing arm pivot shaft 52 for pivotal movement about the first axis A. The first link 70 has an input member 76 and an output member 74, both of which extend radially outwardly from the sleeve 72. The output member 74 is operatively connected to the piston rod of a master brake cylinder shown at 75 in FIG. 7B, via a push rod 77.

Referring to FIG. 3, the swing arm shaft 60 has a pass-through bore 77 in which there are two bushings 79. A brake lever assembly 80 is provided and includes a pedal lever 13, a brake pedal 12, and a pedal lever pivot shaft 82 that passes through the swing arm shaft 60 and that is supported on the radially inner surfaces of the bushings 79 for pivotal movement about the second axis B.

Referring to FIG. 2, an accelerator pedal assembly support structure 34 is provided and has a bed 36 which carries an accelerator pedal assembly 40 which includes an accelerator pedal 14. The accelerator pedal assembly support structure 34 has a bore 42 through which the accelerator pedal assembly support structure 34 is pivotally supported on the radially outer surface of the swing arm shaft 60 for pivotal movement about the second axis B.

The electronic accelerator pedal assembly 40 includes an accelerator pedal lever 37 which holds the accelerator pedal 14 and sensing means for detecting how far the accelerator pedal 14 is depressed, during operation of the vehicle. The accelerator pedal assembly 40 includes an electrical connector 41 for connecting the accelerator pedal assembly 40 to a vehicle control system (not shown) so as to send signals to the vehicle control system indicative of the accelerator pedal position.

The accelerator pedal assembly support structure 34 is slidably mounted in the longitudinal channel 26 of stand 20.

Referring to FIGS. 2 and 7A, a second link 92 that is part of the linkage connects via a pin 96 at a first end to the input member 76 of the first link 70, and connects via a pin 94 at a second end to an output member 84 on the brake pedal lever 13. Depressing the pedal 12 (which constitutes an input member for the lever 13 for pivotal movement of the lever 13 about axis B) thereby causes the first link 70, and therefore the output member 74, to pivot via link 92, which actuates the master brake cylinder 75 (FIG. 7B). While a master brake cylinder 75 is shown, in embodiments wherein the lever 13 is a lever for something other than a brake, the master brake cylinder 75 may instead by some other kind of actuator. Analogously, while the pedal assembly 40 has been described as an accelerator pedal assembly, it is alternatively possible for the pedal assembly 40 to be for controlling some other operation of the vehicle. Thus, the brake pedal 12 may alternatively be referred to as a first pedal 12, and the accelerator pedal 14 may be referred to as a second pedal 14.

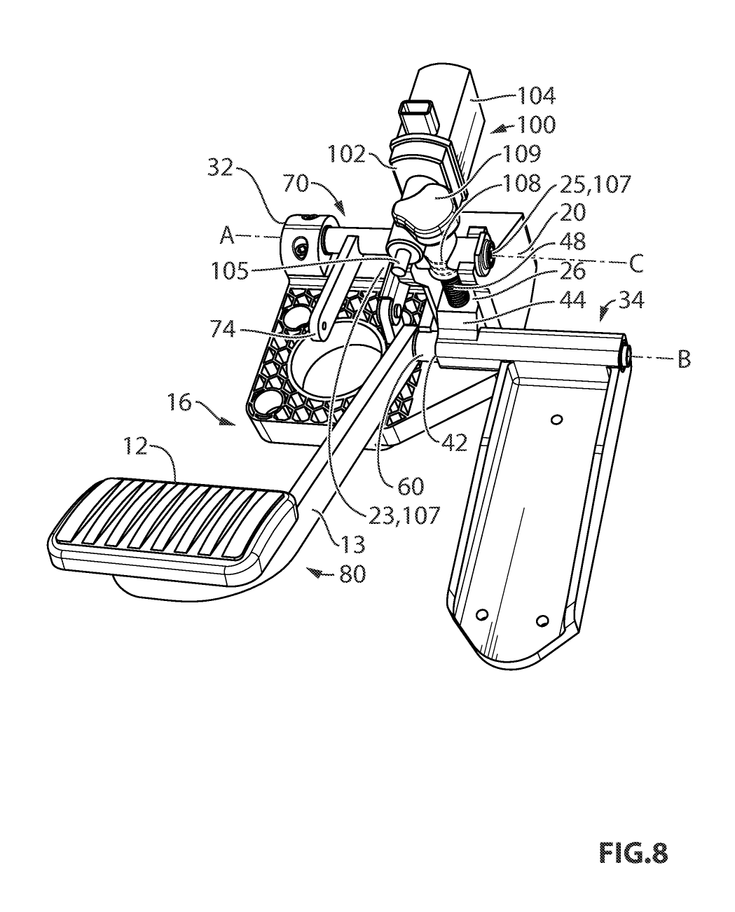

Referring to FIGS. 2 and 8, a drive system is connected to the swing arm 50 to permit a vehicle operator to move the swing arm 50 via a dashboard-mounted control. The drive system may include a motor assembly 100 that includes a motor 104, a lead screw 48 that is rotatable by the motor 104 about an axis Y and a traveler 44 that is part of the accelerator pedal assembly support structure 34 through which the lead screw 48 passes. The axis Y may be transverse to the pivot axes A, B and C.

The traveler 44 is partially seated in the longitudinal channel 26 of stand 20, which constrains the traveler 44 against rotating about Y along during operation of the lead screw 48.

Referring to FIG. 8, the motor assembly 100 is pivotally mounted to the stand 20 of base 16 at a pair of shaft mounts 23 and 25 such that the motor assembly 100 can rock about a third axis C. More particularly, the motor assembly 100 has a casing 102 to which an electric motor 104 is secured. The motor 104 has a rotating output shaft 105 that meshingly engages a helical gear 108 (shown in phantom) nestled within a gear housing portion 109 of the casing 102. The helical gear 108 is fixed to the end of the lead screw 48. The gear housing portion 109 is attached to swivel pins 107 installed in the shaft mounts 23 and 25.

The motor 100 is thus operatively connected to the swing arm 50 so that rotation of the motor 100 is causes movement of the pedals 12 and 14, which hang off the swing arm 50, to vary their distance to the base 16.

A controller, not shown, controls the application of electric power to the motor 104 in order adjust the position of the brake pedal 12 and the accelerator pedal 14 as discussed below. Those skilled in the art will understand that a variety of feedback mechanisms (such as Hall effect sensors, relative or absolute position encoders and the like) known in the art per se may be utilized to determine the current position of the brake and accelerator pedals 12 and 14, if desired, and/or to determine when the brake and accelerator pedals 12 and 14 reach end of travel positions (e.g. using limit switches, timeouts, and/or current spike detectors).

Using FIG. 1 as a reference for direction, the adjustable pedal assembly 10 is shown in the drawings in a first position which may be a forwardmost position, (i.e. where the pedals 12 and 14 are closest to the front of the vehicle). The brake and accelerator pedals 12 and 14 may be moved rearward substantially along line F-R in a manner that provides the same mechanical advantage at any position of the pedals 12 and 14, and substantially maintains the positional relationship between the brake pedal 12 and accelerator pedal 14 so that they move together as a set.

To move the brake and accelerator pedals 12 and 14 rearwardly the controller activates the motor 104 which rotates the lead screw 48. Since the lead screw 48 depends from the motor casing 102 and the traveler 44 of accelerator pedal assembly support structure 34 is constrained against rotation by the longitudinal channel 26 of the base stand 20, the accelerator pedal assembly support structure 34 along with the attendant accelerator pedal 14 travels along the lead screw 48. This movement of the accelerator pedal assembly support structure 34 causes the swing arm pivot shaft 52 of swing arm 50 to pivot about axis A causing the radially offset shaft 60 to swing along an arc D-D (FIG. 5). As the shaft 60 sits within the connecting axial bore 42 of accelerator pedal assembly support structure 34 and is slidingly connected to the lead screw 48 and the attendant pivotal non-translatable motor assembly 100, this swing is taken up by motor assembly 100 which, in view of the geometries involved, will rock somewhat about the third axis C and tilt the lead screw 48 (e.g., from axis Y to axis Y′) as the accelerator pedal assembly support structure 34 moves rearwardly (and will also tilt correspondingly about the axis B).

The brake pedal and lever 12 and 13 substantially follow the travel of the accelerator pedal assembly support structure 34 and the accelerator pedal 14 because the axial shaft 82 of the brake lever assembly 80 is seated within the shaft 60 of swing arm 50 and the connecting axial bore 42 of accelerator pedal assembly support structure 34.

During use of the brake pedal 12, the amount of effort needed to depress the brake pedal 12 will depend on the geometric relationships provided by the first and second links 70 and 92. The geometric relationships involved in determining the pedal effort involved, include: the ratio between the length of the pedal lever 13 and the effective length of the output member 84 mounted thereon about axis B, the ratio between the effective length of the output member 84 about axis B and the length of the input member 76 about axis A (which are connected via second link 92), and the ratio between the input member 76 and the output member 74 about the axis A, which are both mounted to sleeve 72. The effective length of the output member 84 about axis B is the moment arm (i.e. the perpendicular distance, which in this case is the radial distance) between the pivot connection at output member 84 and the axis B. Based on the aforementioned ratios, it can be seen that mathematically, the lengths and effective lengths of several components are cancelled out, such that the amount of effort to depress the brake pedal 12 will depend on the ratio of the length of the pedal lever 13 about axis A and the length of the output member 74 about axis B. Because these two lengths remain constant regardless of the angular position of the shaft 60 about axis A, the mechanical advantage (and thus the pedal effort) provided by the assembly 10 does not vary throughout the travel of the swing arm 50. Providing a consistent pedal effort for different positions of the brake pedal 12 is advantageous in that the pedal assembly 10 can be configured more easily to meet safety standards that may exist in the jurisdiction of operation of the vehicle, that regulate the amount of braking force that must take place for a given brake pedal force. Additionally providing a consistent pedal effort for different positions of the brake pedal 12 is advantageous in that the vehicle driver is not obligated to relearn the braking force to pedal effort relationship associated with the brake pedal 12 whenever a brake lever positional adjustment is made.

It will be noted that the consistent brake pedal effort is provided by an adjustable pedal assembly that is relatively simple in construction, and that can be constructed without the use of cables, which can in some instances be generally undesirable components in pedal assemblies. It will further be noted, however, that, in some embodiments, cables may be used in some places. For example, the second link 92 could be provided by two cables (not shown) instead of being a rigid bar. A first cable could be positioned where the link 92 is positioned in the figures. A second cable could extend between an additional arm 76 that is diametrically opposite to the arm 76 on the sleeve 72, and an additional output member 84 on the pedal lever 13. As a result, when the pedal lever 13 moves in one direction (e.g. when the lever 13 is depressed), the first cable pulls the first arm 76 on the first link 70 so as to drive the piston into the master cylinder to actuate the master cylinder 75 (FIG. 7B), and when the pedal lever 13 moves in the opposite direction (e.g. when the lever 13 returns towards a home position after having been depressed), the second cable pulls the second arm 76 on the first link 70 so as to rotate the first link 70 in the opposite direction so as to extend the piston outwards from the master cylinder 75 to reduce the pressure in the master cylinder.

It will further be noted that, aside from the advantage of providing a consistent brake pedal effort, other aspects of the pedal assembly 10 are advantageous. For example, the movement of the brake pedal 12 during adjustment of the swing arm 50 is nearly linear. As the swing arm 50 pivots about axis A thereby moving axis B, the rotary link 70 remains rotationally stationary about axis A. As a result, the link 92 will force the pedal lever 13 to take on an adjusted angular position about the second axis B. This combination of movement of the swing arm 50 and the change in angular position of the pedal lever 13 provides a generally linear movement of the pedal 12.

Modifications may be made to the embodiments described herein. For example, while some portions of the assembly 10 have been shown herein as integrated units, these portions may be made from individual components that are first formed separately and that are then rigidly connected together. For example, the swing arm components 52, 58, 60 may be fashioned together as an integrated unit (e.g., by casting) or may alternatively be formed individually and then connected together via welds or other suitable joining methods.

In addition, it will be noted that an example embodiment has been shown in which selected elements are concentrically mounted about a common axis (such as brake pedal assembly 80 and accelerator pedal assembly 40 about axis B), and thus move together as a unit when being pivoted about axis A, but pivot independently relative to one another about axis B. However, other ways for pivotally connecting such parts exist. For example, the embodiment shown includes swing arm shaft 60 with an axial bore with the pedal lever shaft 82 mounted therein, both of which are mounted in the axial bore 42 of the accelerator pedal assembly support structure 34. However, it would alternatively be possible for the pedal lever shaft 82 to have an axial bore for receiving the swing arm shaft 60 and for the accelerator pedal assembly support structure 34 to have a shaft mounted in an axial bore of shaft 60. Alternatively, all three of the swing arm shaft 60, the pedal lever shaft 82 and the shaft portion of the accelerator pedal assembly support structure 34 can be solid shafts that are aligned axially and that are connected to one another by additional overlying sleeves. In yet another alternative, all three of the swing arm shaft 60, the pedal lever shaft 82 and the shaft portion of the accelerator pedal assembly support structure 34 can hollow shafts that are aligned axially and that are connected to one another by additional solid shaft stubs. Other structures could alternatively be provided.

It will also be noted that while the adjustable pedal assembly 10 incorporates brake and accelerator pedals, alternative embodiments may have only one pedal. For example, in an embodiment wherein an adjustable brake pedal is provided, but not an adjustable accelerator pedal, the accelerator pedal assembly support structure 34 may lack the bed 36 for holding an accelerator pedal assembly, while still holding the shaft 60 and brake pedal shaft 82 and while still including the traveler 44 for movement along the lead screw 48.

Other modifications may be made to the embodiments described herein without departing from the fair meaning of the appended claims.

1. An adjustable pedal assembly for a vehicle, comprising:
a base mountable to a base support structure in a vehicle;
a swing arm pivotally mounted to the base about a first axis, the swing arm having a free end that defines a second axis that is substantially parallel to the first axis;
a pedal lever connected to the swing arm for pivotal movement about the second axis, wherein the pedal lever has a pedal that is used by a vehicle driver to depress the pedal lever, and wherein the pedal lever has an output member;
a first link that is pivotable about the first axis and includes an output member that is connectable to an actuator, and that further includes an input member; and
a link pivotally connected at a first end to the input member of the first link and at a second end to the output member of the pedal lever.

2. An adjustable pedal assembly as claimed in claim 1, further comprising a drive system operatively connected to the swing arm to pivot the swing arm about the first axis.

3. An adjustable pedal assembly as claimed in claim 2, wherein the drive system includes:
a motor connected to the base;
a lead screw driven by the motor; and
a traveler connected to the swing arm and mounted on the lead screw that is constrained from rotating by the base, such that rotation of the lead screw generates translation of the traveler relative thereto.

4. An adjustable pedal assembly as claimed in claim 3, wherein the motor is pivotally connected to the base about a third axis and wherein the traveler is pivoted about the second axis during translation relative to the lead screw, thereby driving pivoting of the motor about the third axis.

5. An adjustable pedal assembly as claimed in claim 4, wherein:
the swing arm has a swing arm free end shaft that includes a first axial bore, and the pedal lever shaft is mounted therein, and
the traveler is connected to a support structure that includes a second axial bore and the swing arm free end shaft is mounted therein.

6. An adjustable pedal assembly as claimed in claim 3, wherein the pedal lever is a first pedal lever and wherein the traveler is connected to a support structure for a second pedal lever that carries a second pedal.

7. An adjustable pedal assembly as claimed in claim 1, wherein the pedal lever has a pedal lever shaft connected thereto and the swing arm has a swing arm free end shaft connected thereto, wherein one of the pedal lever shaft and the swing arm free end shaft has an axial bore and the other of the pedal lever shaft and the swing arm free end shaft are pivotally supported within said bore.

8. An adjustable pedal assembly as claimed in claim 1, wherein the swing arm has a swing arm pivot shaft and the first link includes a sleeve concentrically mounted for pivotal movement over the swing arm pivot shaft.

9. An adjustable pedal assembly as claimed in claim 1, wherein the actuator is a master brake cylinder.

10. An adjustable pedal assembly as claimed in claim 1, wherein the pedal lever is a first pedal lever and wherein the adjustable pedal assembly includes a second pedal lever and a second pedal thereon.

11. An adjustable pedal assembly as claimed in claim 10, wherein the second pedal lever is part of a second pedal assembly that is supported on a second pedal assembly support structure that is pivotable about the second axis independently of the first pedal lever.

12. An adjustable pedal assembly as claimed in claim 11, wherein the first pedal lever is a brake pedal lever and the actuator is a master brake cylinder, and wherein the second pedal lever is an accelerator pedal lever that is operable to control the acceleration of the vehicle
